(19) United States
(12) Patent Application Publication
(10) Pub. No.: US 2017/0134060 A1
(43) Pub. Date: May 11, 2017

(54) LOW VOLTAGE DRIVING CIRCUIT FOR TRACKING MAXIMUM POWER POINT AND LOW VOLTAGE DRIVING DEVICE INCLUDING THE SAME

(71) Applicant: ELECTRONICS AND TELECOMMUNICATIONS RESEARCH INSTITUTE, Daejeon (KR)

(72) Inventor: Jong Pil IM, Daejeon (KR)

(21) Appl. No.: 15/088,920

(22) Filed: Apr. 1, 2016

(30) Foreign Application Priority Data
Nov. 9, 2015 (KR) 10-2015-0156553

(51) Int. Cl. H04B 1/3827; H04W 4/00; H02M 3/335

(52) U.S. Cl. CPC H04B 1/385; H02M 3/33546; H02M 3/33569; H04W 4/005

(57) ABSTRACT

An electronic circuit includes an electricity generating element circuit outputting an input voltage and an input current according to a temperature of an electricity generating element, a current detecting circuit detecting the input current, a power tracking control circuit receiving the detected input current, detecting the input voltage, and outputting a control signal, a switch selecting circuit selectively outputting switch selection signals in response to the control signal, a switch circuit adjusting a resistance value of a resistor according to the switch selection signals that are selectively output from the switch selecting circuit, the resistor being connected to an output terminal of the electricity generating element circuit, and a transformer transforming the input voltage to output an increased voltage, wherein the power tracking control circuit adjusts the control signal such that power according to the input current and the input voltage is maintained in a reference ratio.

### CROSS-REFERENCE TO RELATED APPLICATIONS

The present application claims priority under 35 U.S.C. §119 of Korean Patent Application No. 10-2015-0156553, filed on Nov.9, 2015, the entire contents of which are hereby incorporated by reference.

### BACKGROUND

The present disclosure herein relates to a low voltage driving circuit and a low voltage driving device including the same, and more particularly, to a low voltage driving circuit for tracking a maximum power point and a low voltage driving device including the same.

### TECHNICAL FIELD

An electricity generating element generates power according to a temperature difference. When the temperature difference generated from the electricity generating element is small, a voltage output from the electricity generating element is very low. Accordingly, there are various techniques for obtaining power necessary for driving even in a low output voltage.

For example, there is a low voltage start-up method using a Micro Electro Mechanical System (MEMS) switch. The MEMS switch may increase a small voltage of tens mV to hundreds mV instead of an MOS element. However, the MEMS switch requires an additional MEMS process besides a CMOS process and accordingly a production process is complex and incurs costs. Accordingly, various techniques are necessary to address such limitations.

### SUMMARY

The present disclosure provides a low voltage driving circuit for tracking a maximum power point and a low voltage driving device including the same which increases a low voltage generated by an electricity generating element and includes a circuit for tracking a maximum power point in order to provide maximum power to an output stage.

In some example embodiments, an electronic circuit comprises an electricity generating element circuit configured to output an input voltage and an input current according to a temperature of an electricity generating element, a current detecting circuit connected to the electricity generating element circuit and configured to detect the input current, a power tracking control circuit configured to, receive the detected input current, detect the input voltage, and output a control signal according to the detected input current and the detected input voltage, a switch selecting circuit configured to selectively output a plurality of switch selection signals in response to the control signal, a switch circuit configured to adjust a resistance value of a resistor according to the plurality of switch selection signals that are selectively output from the switch selecting circuit, the resistor being connected to an output terminal of the electricity generating element circuit, and a transformer connected between the electricity generating element circuit and the switch circuit, and configured to transform the input voltage to output an increased voltage, wherein the power tracking control circuit adjusts the control signal such that power according to the input current and the input voltage is maintained in a reference ratio.

In some example embodiments, the control signal comprises an activation signal for gradually increasing the resistance value of the resistor.

In some example embodiments, the control signal comprises a deactivation signal for gradually decreasing the resistance value of the resistor.

In some example embodiments, the control signal comprises a maintenance signal for constantly maintaining the resistance value of the resistor such that the power is maintained in the reference ratio.

In some example embodiments, an electronic circuit further comprises a diode connected to the transformer and configured to receive the increased voltage and an output circuit configured to receive, from the diode, an output voltage according to the increased voltage.

In some example embodiments, an electronic circuit further comprises a capacitor connected between the transformer and the switch circuit, and configured to apply, to the switch circuit, an AC signal obtained by removing a DC signal from the increased voltage.

In some example embodiments, the transformer comprises a primary winding, a first end of the primary winding being connected to the electricity generating element circuit, s second end of the primary winding being connected to the switch circuit, and a secondary winding, a first end of the secondary winding being connected to the capacitor, and a second end of the secondary winding being connected to a ground terminal.

In some example embodiments, the switch circuit comprises a plurality of transistors, first ends of the plurality of transistors being connected to the primary winding of the transformer, second ends of the plurality of transistors being connected to the ground terminal; and a plurality of transmission gates, first ends of the plurality of transmission gates being respectively connected to gate terminals of the plurality of transistors, second ends of the plurality of transmission gates receiving the AC signal, gate terminals of the plurality of transmission gates receiving the plurality switch selection signals that are selectively output from the switch selecting circuit, wherein the plurality of transmission gates is activated according to the plurality of switch selection signals that are selectively output from the switch selecting circuit.

In some example embodiments, the plurality of transistors has different turn-on resistance values from one another.

In some example embodiments, a turn number of the secondary winding is larger than a turn number of the primary winding.

In some example embodiments, an electronic device comprise a low voltage driving circuit configured to generate power, and a modem configured to receive the power from the low voltage driving circuit to perform communication, wherein the low voltage driving circuit comprises an electricity generating element circuit configured to output an input voltage and an input current according to a temperature of an electricity generating element, a current detecting circuit connected to the electricity generating element circuit and configured to detect the input current, a power tracking control circuit configured to, receive the detected input current, detect the input voltage, and output a control signal according to the detected input current and detected input voltage, a switch selecting circuit configured to selectively output a plurality of switch selection signals in response to the control signal, a switch circuit configured to adjust a resistance value of a resistor according to the plurality of switch selection signals that are selectively output from the switch selecting circuit, the resistor being connected to an output terminal of the electricity generating element circuit, and a transformer connected between the electricity generating element circuit and the switch circuit, and configured to transform the input voltage to output an increased voltage, wherein the power tracking control circuit adjusts the control signal such that power according to the input current and the input voltage is maintained in a reference ratio.

In some example embodiments, an electronic device further comprises a sensing device configured to receive the power through the low voltage driving circuit and to output sensing information through the modem.

In some example embodiments, an electronic device further comprises a data collector device configured to receive the power through the low voltage driving circuit and to collect sensing information through the modem.

In some example embodiments, the modem communicates through a wireless sensor network (WSN).

In some example embodiments, the electronic is a wearable device that receives the power through the low voltage driving circuit.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a circuit diagram of a low voltage driving circuit according to an embodiment of the inventive concept;

FIG. 2 is a graph showing an output power characteristic of an electricity generating element unit according to an embodiment of the inventive concept;

FIG. 3 is a graph showing a maximum output power characteristic of an electricity generating element unit according to an embodiment of the inventive concept;

FIG. 4 is a circuit diagram illustrating in more detail the low voltage driving circuit of FIG. 1;

FIG. 5 is a conceptual diagram illustrating a network system including a low voltage driving circuit according to an embodiment of the inventive concept; and

FIG. 6 is a conceptual diagram illustrating wearable devices including low voltage driving circuits according to an embodiment of the inventive concept.

### DETAILED DESCRIPTION

Hereinafter, specific embodiments will be described in detail with reference to the accompanying drawings. The present invention may be variously modified and realized in various forms, and thus specific embodiments will be exemplified in the drawings and described in detail hereinbelow. However, the present invention is not limited to the specific disclosed forms, and needs to be construed to include all modifications, equivalents, or replacements included in the spirit and technical range of the present invention. Like reference numerals refer to like elements throughout. In the drawings, the dimensions of structures are exaggerated for clarity of illustration. It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the singular forms “a,” “an” and “the” are intended to include the plural forms as well, unless the context clearly indicates otherwise.

It will be further understood that the terms “comprises”, “comprising,”, “includes” and/or “including”, when used herein, specify the presence of stated features, integers, steps, operations, elements, components or combinations thereof, but do not preclude the presence or addition of one or more other features, integers, steps, operations, elements, components, or combinations thereof. It will also be understood that when a part such as a layer, a film, a region, or a plate, etc., is referred to as being ‘on’ another part, it can be “directly on” the other part, or intervening part may also be present. On the contrary, it will be understood that when a part such as a layer, a film, a region, or a plate, etc., is referred to as being ‘under’ another part, it can be “directly under”, and one or more intervening parts may also be present.

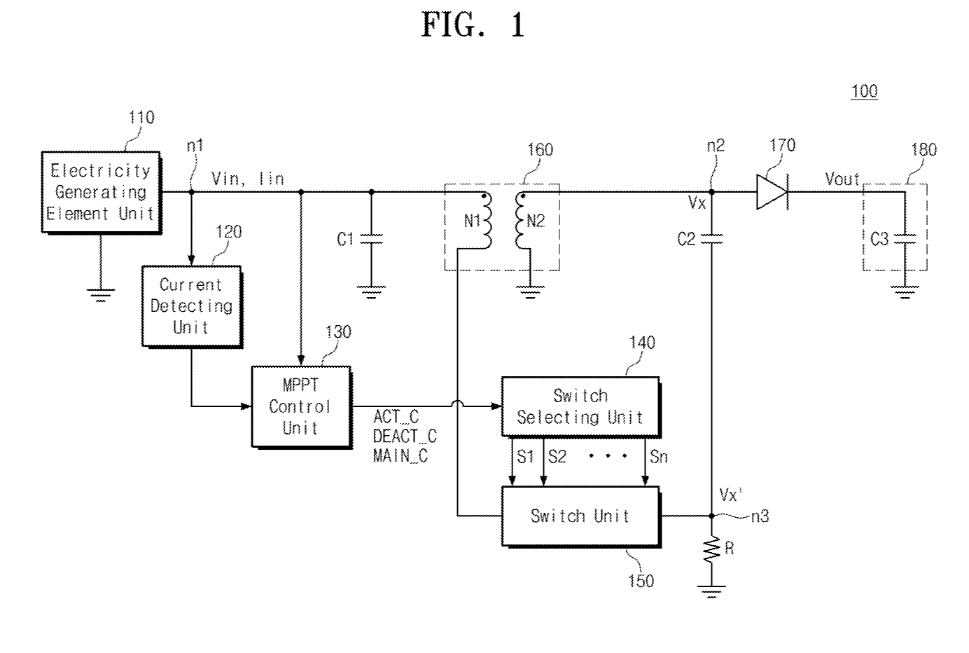

FIG. 1 is a circuit diagram of a low voltage driving circuit according to an embodiment of the inventive concept. Referring to FIG. 1, a low voltage driving circuit 100 may include an electricity generating element unit 110, a current detecting unit 120, a maximum power point tracking (MPPT) control unit 130, a switch selecting unit 140, a switch unit 150, a first capacitor C1, a transformer 160, a second capacitor C2, a diode 170, and an output unit 180. A low voltage driving circuit is an electronic circuit for generating a driving voltage by using a low voltage.

In order to explain the inventive concept, it is assumed that the electricity generating unit 110 may include a thermoelectricity generating element. The electricity generating element unit 110 may generate thermo-electromotive force through a Seebeck effect. In detail, the electricity generating element unit 110 may have a structure in which both ends of two types of metals or semiconductors are joined. When a temperature difference is generated in the electricity generating element unit 110, a current and a both-end voltage are generated, and accordingly a thermo-electromotive force is generated. Accordingly, the electricity generating element unit 110 applies an input voltage Vin and an input current Iin, which are generated by the both-end voltage according to a change in temperature difference between the both ends, to the current detecting unit 120 connected to a first node n1 and the MPPT control unit 130.

The current detecting unit 120 is connected to the first node n1. The current detecting unit 120 periodically detects the input current Iin applied from the electricity element unit 110. The current detecting unit 120 outputs the detected input current Iin to the MPPT control unit 130.

The MPPT control unit 130 is connected to the first node n1. The MPPT control unit 130 receives the detected input current Iin from the current detection unit 120. In addition, the MPPT control unit 130 receives the input voltage Vin output from the electricity generating element unit 110. The MPPT control unit 130 may calculate a power value output from the electricity generating element unit 110 by using the input current Iin and input voltage Vin.

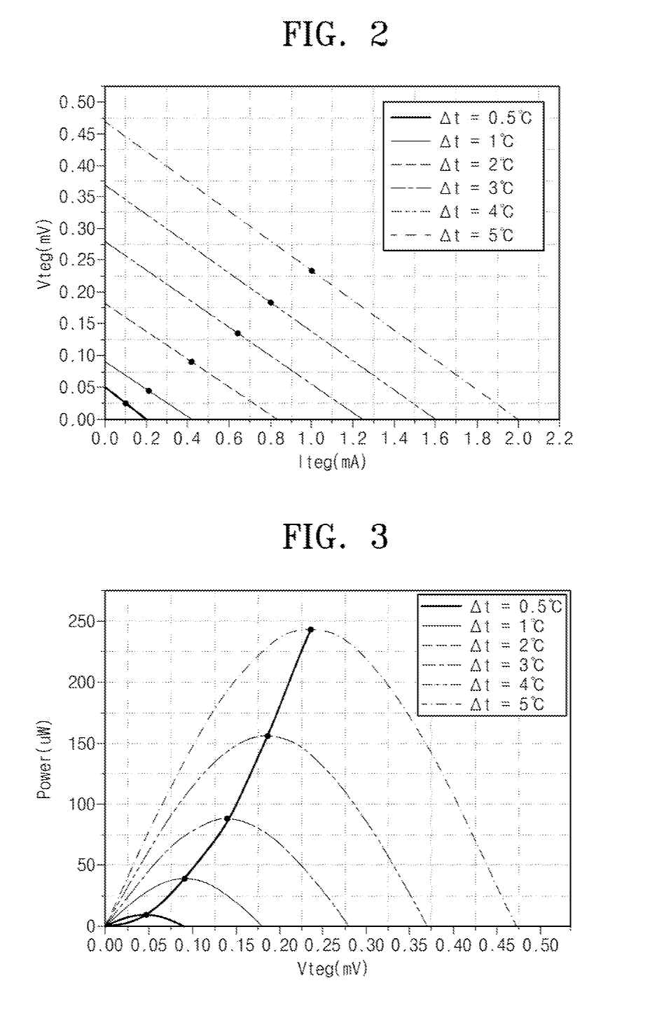

The MPPT control unit 130 may output a control signal for controlling the switch selecting unit 140. In detail, the MPPT control unit 130 may output an activation control signal ACT_C, a deactivation control signal DEACT_C, and a maintenance control signal MAIN_C. The MPPT control unit 130 may control the switch selecting unit 140 to track a maximum power point. For example, the MPPT control unit 130 may output the activation control signal ACT_C for sequentially increasing a resistance value of the switch unit 150 until a maximum power value is achieved. On the contrary, the MPPT control unit 130 may output the deactivation control signal DEACT_C for sequentially decreasing a resistance value of the switch unit 150 until the maximum power value is achieved. The MPPT control unit 130 outputs the maintenance controls signal MAIN_C for maintaining a resistance value at a moment when a currently calculated power value become smaller than a previous power value. A description thereabout will be described in more detail through FIGS. 2 to 4.

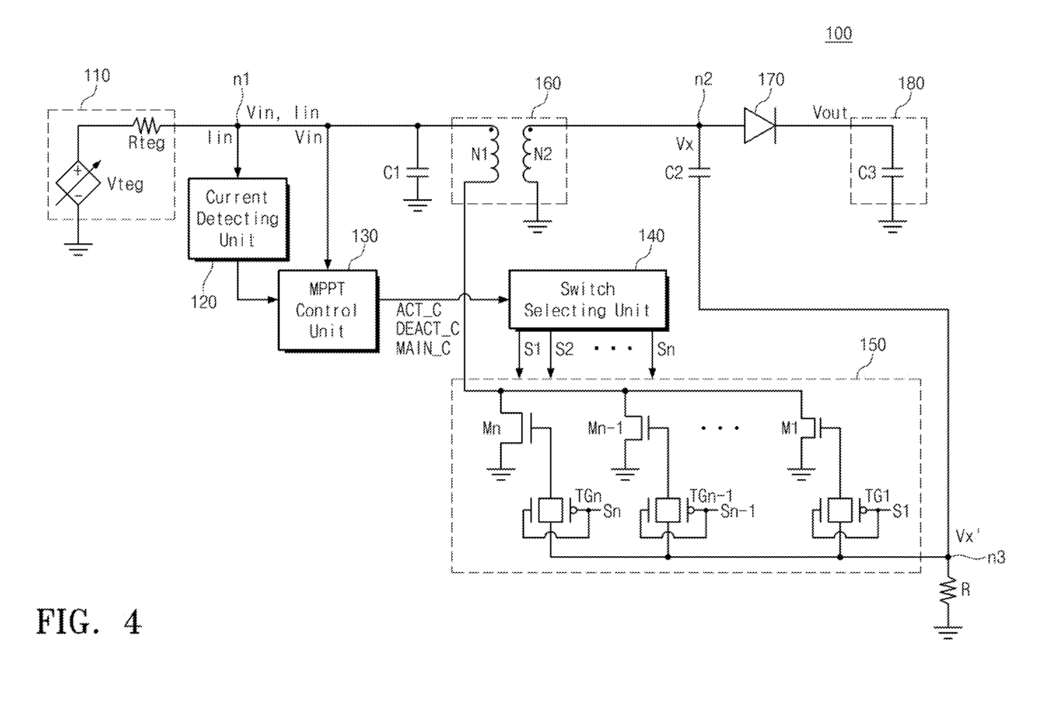

The switch unit 150 is connected between the transformer 160 and a second node n2 through a positive feedback loop. The switch selecting unit 140 may receive a control signal from the MPPT control unit 130. The switch selecting unit 140 may selectively output a plurality of switch selection signals S1 to Sn, where n is an integer, to the switch unit 150 in response to the control signal. The switch unit 150 may receive the plurality of switch selection signals S1 to Sn to adjust a resistance value. When the resistance value of the switch unit 150 is adjusted, magnitudes of the input current lin and the input voltage Vin may be adjusted. A description thereabout will be described in more detail through FIG. 4.

The first capacitor C1 may be disposed between the first node n1 and the transformer 160. The embodiment of the inventive concept is not limited thereto, and the first capacitor C1 may be included in the MPPT control unit 130. The first capacitor C1 may be charged with the input voltage Vin. The first capacitor C1 may maintain constantly the input voltage Vin may be supplied to the transformer 160.

The transformer 160 is connected between the first node n1 and the second node n2. A primary winding of the transformer 160 is connected to the first node n1 and a secondary winding is connected to the second node n2. The transformer 160 may transform the input voltage Vin according to a ratio of a turn number N1 of the primary winding and a turn number N2 of the secondary winding. The transformer 160 of the inventive concept is assumed that the turn number N2 of the secondary winding is larger than the turn number N1 of the primary winding. For example, when the ratio of the turn number N1 of the primary winding and the turn number N2 of the secondary winding is 1:600, a voltage increased by 600 times than the input voltage Vin may be applied to the second node n2. This is just an example for explaining the inventive concept, and the embodiment of the inventive concept is not limited thereto.

A voltage Vx increased by the transformer 160 may be applied to the second node n2. The increased voltage Vx may be applied to the diode 170 and the second capacitor C2 connected to the second n2.

The second capacitor C2 may perform AC coupling of the increased voltage Vx. In detail, the second capacitor C2 may pass an AC signal of the increased voltage Vx and may cut off a DC signal. Accordingly, an AC signal Vx′ in which the DC signal may be cut off by the second capacitor C2 may be applied to a third node n3. The AC signal Vx′ may be applied to the switch unit 150 through the third node n3. The AC signal Vx′ may be used as a gate signal for a plurality of switches included in the switch unit 150. A description thereabout will be described in detail through FIG. 4. A resistor R may be connected to the third node n3. The resistor R may enhance a gain of the positive feedback loop.

The increased voltage Vx may be applied as an output voltage Vout to the output unit 180 through the diode 170. The output voltage Vout may be a voltage reduced from the increased voltage Vx by a voltage drop through a diode. The output voltage Vout may be used as a driving voltage of various loads (not illustrated). The third capacitor C3 of the output unit 180 may be charged with the output voltage Vout. The third capacitor C3 may constantly maintain the output voltage Vout supplied to the loads (not illustrated).

FIG. 2 is a graph showing an output power characteristic of an electricity generating element unit according to an embodiment of the inventive concept. FIG. 2 shows an electricity generating characteristic curve according to a temperature difference between both ends of the electricity generating element unit 110. A horizontal axis of the graph of FIG. 2 denotes a current Item generated by the electricity generating element unit 110. In addition, a vertical axis denotes both-end voltage Vteg generated by the electricity generating element unit 110. Referring to FIG. 2, as the temperature difference At of both ends of the electricity generating element unit 110 increases, magnitudes of the current Item and the both-end voltage Vteg generated by the electricity generating element unit 110 also increase.

FIG. 3 is a graph showing a maximum output power characteristic of an electricity generating element unit according to an embodiment of the inventive concept. FIG. 3 shows a power characteristic curve according to an increase of the both-end voltage of the electricity generating element unit 110. A horizontal axis of the graph of FIG. 3 denotes the both-end voltage Vteg generated by the electricity generating element unit 110. In addition, a vertical axis denotes power output from the electricity generating element unit 110. Referring to FIG. 3, as the temperature difference At of both ends of the electricity generating element unit 110 increases, magnitude of power output from the electricity generating element unit 110 also increases. Referring FIGS. 2 and 3, it may be seen that when the magnitudes of the current Item and the both-end voltage Vteg are respectively halves of respective maximum values in respective graphs, maximum power is output from the electricity generating element unit 110.

FIG. 4 is a circuit diagram illustrating in more detail the low voltage driving circuit of FIG. 1. Referring to FIG. 4, a low voltage driving circuit 100 may include an electricity generating element unit 110, a current detecting unit 120, an MPPT control unit 130, a switch selecting unit 140, a switch unit 150, a first capacitor C1, a transformer 160, a second capacitor C2, a diode 170, and an output unit 180.

According to a temperature change, a both-end voltage Vteg and resistance Rteg of the electricity generating element unit 110 are variable. Power P output from the electricity generating element unit 110 may be defined as the following Equation (1).

$$P = IinVin = \frac{Vin ( Vteg - Vin )}{Rteg} [ W ] \qquad ( 1 )$$

In Equation (1), “Iin” and “Vin” may respectively indicate an input current Iin and an input voltage Vin output from the electricity generating element unit 110. The electricity generating element unit 110 may output the input current Iin and the input voltage Vin according to the variable both-end voltage Vteg and the resistance Rteg to a first node n1.

The current detecting unit 120 may be connected to the first node n1 and periodically detects the input current Iin. The current detecting unit 120 may be transmit the detected input current Iin to the MPPT control unit 130. The MPPT control unit 130 may be connected to the first node n1. The MPPT control unit 130 may be receive the input current Iin from the current detecting unit 120 and may be detect an input voltage Vin of the first node n1.

$$Vin ( max ) = \frac{Vteg}{2} and P max = \frac{{Vteg}^{2}}{4 Rteg} \qquad ( 2 )$$

Referring to FIG. 3 and Equation (2), a maximum input voltage (Vin(max)) may be generated when the input voltage Vin has a magnitude of a half of the both-end voltage Vteg.

$$P max = \frac{{Vteg}^{2}}{4 Rteg} \qquad ( 3 )$$

When the maximum input voltage Vin(max) of Equation (2) is substituted to Equation (1), maximum power Pmax may be obtained according to Equation (3). Accordingly, the MPPT control unit 130 applies a control signal to the switch selecting unit 140 in order to control the input voltage Vin to have magnitude of a half of the both-end voltage Vteg. In detail, the MPPT control unit 130 may adjust the control signal applied to the switch selecting unit 140 in order to identically adjust the resistance Rteg of the electricity generating element unit 110 and the resistance value of the switch unit 150. The switch selecting unit 140 may selectively output a plurality of switch selection signals S1 to Sn in response to the control signal. Since a description about the control signal applied from the MPPT control unit 130 has been described in relation to FIG. 1, a detailed description thereabout will be omitted.

The switch unit 150 is connected between the transformer 160 and a second node n2 through a positive feedback loop. The switch unit 150 may include a plurality of transmission gates TG1 to TGn and a plurality of transistors M1 to Mn. The plurality of switch selection signals S1 to Sn may be applied to gate terminals of the plurality of transmission gates TG1 to TGn. One end of the plurality of transmission gates TG1 to TGn may be connected to the third node n3, and the other end thereof may be respectively connected to the gate terminals of the plurality of transistors M1 to Mn.

Each of the plurality of transistors M1 to Mn may be an NMOS transistor. However, the embodiment of the inventive step is not limited thereto. The gate terminals of the plurality of transistors M1 to Mn may be respectively connected to the plurality of transmission gates TG1 to TGn. In addition, one end of the plurality of transistors M1 to Mn may be connected to the first winding of the transformer and the other end thereof is connected to a ground terminal. The plurality of transmission gates TG1 to TGn may be turned on by the plurality of switch selection signals S1 to Sn. The sizes of the plurality of transistors M1 to Mn may be different from each other. For example, the sizes may be increased from a first transistor M1 toward an n-th transistor Mn. Accordingly, the plurality of transistors M1 to Mn have different turn-on resistances from each other. For another example, the sizes may be decreased from the first transistor M1 toward the n-th transistor Mn. Here, the turn-on resistance represents magnitude of a resistor when the transistor may be in a turned-on state.

The plurality of transmission gates TG1 to TGn may be selectively turned on by the plurality of switch selection signals S1 to Sn. The AC signal Vx′ may be applied from the third node n3 through the turned-on transmission gates TG1 to TGn. The AC signal Vx′ may be applied to the gate terminals of the transistors connected to the turned-on transmission gates. The input current Iin may be applied to one end of the turned-on transistors. Since the transistors M1 to Mn may be connected in parallel, the magnitude of the input current Iin decreases in proportion to the number of turned-on transistors. The input current Iin may decrease until the input voltage Vin is adjusted to a half of the both-end voltage Vteg.

The first capacitor C1 disposed between the first node n1 and the transformer 160 may constantly supply the input voltage Vin to the transformer 160. The transformer 160 is connected between the first node n1 and the second node n2, and increases the input voltage Vin.

A voltage Vx increased by the transformer 160 may be applied to the second node n2 and the increased voltage Vx may be applied to the diode 170 and the second capacitor C2 connected to the second node n2. The second capacitor C2 may apply an AC signal Vx′ of the increased voltage Vx. The AC signal Vx′ may be used as gate signals of the plurality of transistors M1 to Mn included in the switch unit 150.

The increased voltage Vx may be applied as an output voltage Vout to the output unit 180 through the diode 170. The output voltage Vout may be used as a driving voltage of various loads (not illustrated). The third capacitor C3 may constantly maintain the output voltage Vout supplied to the loads (not illustrated). A resistor R is connected to the third node n3. The resistor R may improve a gain of the positive feedback loop.

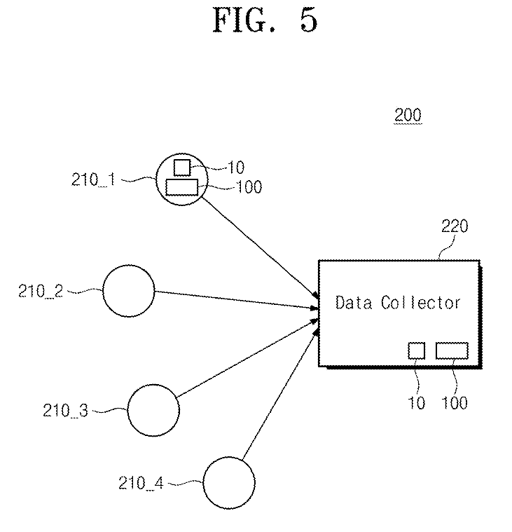

FIG. 5 is a conceptual diagram illustrating a network system including a low voltage driving circuit according to an embodiment of the inventive concept. The network system 200 may include sensing devices 210_1 to 210_4. The network system 200 of the inventive concept is assumed to include 4 sensing evices 210_1 to 210_4. However, the embodiment of the present invention is not limited thereto. The network system 200 may include 4 or less, or 4 or more sensing devices.

The sensing device 210_1to 201_4 may include at least one type of sensors. For example, the sensing devices 201_{—1} to 210_4 may include at least one of a temperature sensor, infrared sensor, speed sensor, sound sensor, electromyogram sensor, optical sensor, and pressure sensor. The types of sensors are just an example of practicing the inventive concept, and are not limited thereto.

The sensing devices 210_1 to 210_4 may be located on subjects to be monitored. For example, the sensing devices 210_1 to 210_4 may be disposed in a department store, public office, large market, amusement park, shopping center, or body, etc. The sensing devices 210_1 to 210_4 may output sensed information to a data collector 220 according to purposes.

The data collector device 220 may collect and analyze the sensed information received from the sensing devices 210_1 to 210_4. The data collector 220 and the sensing devices 210_1 to 210_4 may communicate through wireless communication. For example, the data collector 220 and the sensing devices 210_1 to 210_4 may communicate through a wireless sensor network (WSN). The embodiment of the inventive concept is not limited thereto, and the data collector 220 and the sensing devices 210_1 to 210_4 may communicate through a 3G, 4G, WiFi, Bluetooth, or Zigbee manner. A first sensing device 210_1 and the data collector 220 communicate through a modem 10. The model 10 may receive driving power from the low voltage driving circuit 100. Not only the first sensing device 210_1 but also the remaining sensing devices 210_2 to 210_4 may include the modem 10.

The first sensing device 210_1 and the data collector device 220 are electronic device including the low voltage driving circuit 100 described in relation to FIGS. 1 to 3. The first sensing device 210_1 and the data collector 220 may receive driving power from the low voltage driving circuit 100. The low voltage driving circuit 100 may generate a voltage by using a temperature difference occurring between the first sensing device 210_1 and the data collector 220. The low voltage driving circuit 100 may increase the voltage generated by the temperature difference and deliver maximum power to the first sensing device 210_1 and the data collector 220. The low voltage driving circuit may be included in not only the first sensing device 210_1 but also the remaining sensing devices 210_2 to 210_4. The low voltage driving circuit 100 may provide excellent power efficiency in a low power environment such as a WSN.

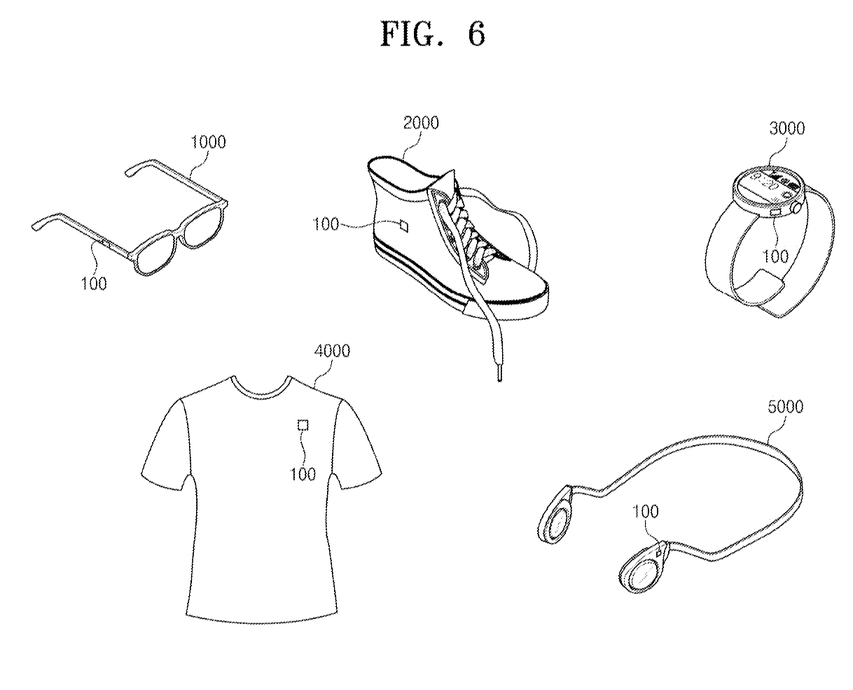

FIG. 6 is a conceptual diagram illustrating wearable devices including low voltage driving circuits according to an embodiment of the inventive concept. A wearable device may be worn on a body and used in fields of well-being, health care, medical care, or education.

The wearable devices 1000 to 5000 may be smart glasses, a smart shoe, a wearable watch, clothes, or earphones. Each of the wearable devices 1000 to 5000 may exchange information with a user (not illustrated). Each of the wearable devices 1000 to 5000 may exchange information with each other. The user and the wearable devices 1000 to 5000 may exchange information with each other through one of wireless wide area network (WWAN) communication (e.g. RF wireless communication, or IEEE 802.20), wireless metropolitan area network (WMAN) communication (e.g. IEEE 802.16, WiMAX), wireless local area network (WLAN) communication (e.g. NFC, BLE, WiFi, Ad-Hoc, etc.) and wireless personal area network (WPAN) communication (e.g. IEEE 802.15, ZigBee, Bluetooth, UWB, RFID, Wireless USB, Z-Wave, body area network).

In addition, the wearable devices 1000 to 5000 may include an energy converting device 200 described in relation to FIGS. 1 to 3. The wearable devices 1000 to 5000 according to embodiments of the inventive concept may provide driving energy through the low voltage driving circuit 100, which includes the electricity generating element unit 110, instead of a secondary cell. In detail, the low voltage driving circuit 100 may increase the voltage generated by the temperature difference and also supply maximum power to the wearable devices 1000 to 5000. The low voltage driving circuit 100 may provide excellent power efficiency in a low power environment such as the wearable devices 1000 to 5000.

According to embodiments of the inventive concept, a low voltage driving circuit further includes a maximum power point tracking circuit for tracking a maximum power point, and adjusts an input voltage to a predetermined ratio to apply the adjusted voltage to one end of a transformer. Accordingly, a low voltage driving circuit having improved output efficiency and a low voltage driving device including the same are provided.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. An electronic circuit comprising:
an electricity generating element circuit configured to output an input voltage and an input current according to a temperature of an electricity generating element;
a current detecting circuit connected to the electricity generating element circuit and configured to detect the input current;
a power tracking control circuit configured to,
receive the detected input current,
detect the input voltage, and
output a control signal according to the input detected current and the detected input voltage;
a switch selecting circuit configured to selectively output a plurality of switch selection signals in response to the control signal;
a switch circuit configured to adjust a resistance value of a resistor according to the plurality of switch selection signals that are selectively output from the switch selecting circuit, the resistor being connected to an output terminal of the electricity generating element circuit; and
a transformer connected between the electricity generating element circuit and the switch circuit, and configured to transform the input voltage to output an increased voltage,
wherein the power tracking control circuit adjusts the control signal such that power according to the input current and the input voltage is maintained in a reference ratio.

2. The electronic circuit of claim 1, wherein the control signal comprises an activation signal for gradually increasing the resistance value of the resistor.

3. The electronic circuit of claim 1, wherein the control signal comprises a deactivation signal for gradually decreasing the resistance value of the resistor.

4. The electronic circuit of claim 1, wherein the control signal comprises a maintenance signal for constantly maintaining the resistance value of the resistor such that the power is maintained in the reference ratio.

5. The electronic circuit of claim 1, further comprising:
a diode connected to the transformer and configured to receive the increased voltage; and
an output circuit configured to receive, from the diode, an output voltage according to the increased voltage.

6. The electronic circuit of claim 1, further comprising:
a capacitor connected between the transformer and the switch circuit, and configured to apply, to the switch circuit, an AC signal obtained by removing a DC signal from the increased voltage.

7. The electronic circuit of claim 6, wherein the transformer comprises:
a primary winding, a first end of the primary winding being connected to the electricity generating element circuit, s second end of the primary winding being connected to the switch circuit; and
a secondary winding, a first end of the secondary winding being connected to the capacitor, and a second end of the secondary winding being connected to a ground terminal.

8. The electronic circuit of claim 7, wherein the switch circuit comprises:
a plurality of transistors, first ends of the plurality of transistors being connected to the primary winding of the transformer, second ends of the plurality of transistors being connected to the ground terminal; and
a plurality of transmission gates, first ends of the plurality of transmission gates being respectively connected to gate terminals of the plurality of transistors, second ends of the plurality of transmission gates receiving the AC signal, gate terminals of the plurality of transmission gates receiving the plurality switch selection signals that are selectively output from the switch selecting circuit,
wherein the plurality of transmission gates is activated according to the plurality of switch selection signals that are selectively output from the switch selecting circuit.

9. The electronic circuit of claim 8, wherein the plurality of transistors has different turn-on resistance values from one another.

10. The electronic circuit of claim 7, wherein a turn number of the secondary winding is larger than a turn number of the primary winding.

11. An electronic device comprising:
a low voltage driving circuit configured to generate power; and
a modem configured to receive the power from the low voltage driving circuit to perform communication,
wherein the low voltage driving circuit comprises:
an electricity generating element circuit configured to output an input voltage and an input current according to a temperature of an electricity generating element;
a current detecting circuit connected to the electricity generating element circuit and configured to detect the input current;
a power tracking control circuit configured to,
receive the detected input current,
detect the input voltage, and
output a control signal according to the detected input current and the detected input voltage;
a switch selecting circuit configured to selectively output a plurality of switch selection signals in response to the control signal;
a switch circuit configured to adjust a resistance value of a resistor according to the plurality of switch selection signals that are selectively output from the switch selecting circuit, the resistor being connected to an output terminal of the electricity generating element circuit; and
a transformer connected between the electricity generating element circuit and the switch circuit, and configured to transform the input voltage to output an increased voltage,
wherein the power tracking control circuit adjusts the control signal such that power according to the input current and the input voltage is maintained in a reference ratio.

12. The electronic device of claim 11, further comprising a sensing device configured to receive the power through the low voltage driving circuit and to output sensing information through the modem.

13. The electronic device of claim 11, further comprising a data collector device configured to receive the power through the low voltage driving circuit and to collect sensing information through the modem.

14. The electronic device of claim 11, wherein the modem communicates through a wireless sensor network (WSN).

15. The electronic device of claim 11, wherein the electronic device is a wearable device that receives the power through the low voltage driving circuit.
